(19) United States
(12) Patent Application Publication
(10) Pub. No.: US 2014/0137008 A1
(43) Pub. Date: May 15, 2014

(54) APPARATUS AND ALGORITHM FOR IMPLEMENTING PROCESSING ASSIGNMENT INCLUDING SYSTEM LEVEL GESTURES

(71) Applicant: SHANGHAI POWERMO INFORMATION TECH. CO. LTD, Shanghai (CN)

(72) Inventors: Qi Pan, Shanghai (CN); Xiong-Hui Guo, Shanghai (CN); Jian-Jing Shen, Shanghai (CN)

(73) Assignee: SHANGHAI POWERMO INFORMATION TECH. CO. LTD., Shanghai (CN)

(21) Appl. No.: 13/674,101

(22) Filed: Nov. 12, 2012

(51) Int. Cl. G06F 3/048

(52) U.S. Cl. 715/761

(57) ABSTRACT

A method for defining a set of gesture sequence controlling an order of priority for processing assignment with respect to an operating system of an electronic device hosting an application program, and to the application program itself is provided by the following steps: a start position is determined as whether being detected in the menu area, followed by detecting and determining if a set of gesture sequence is a swipe; upon determining that the starting point is not detected in the menu area, the gesture sequence is sent for application level processing first; upon determining that the set of gesture sequence is a swipe, the gesture sequence sent for system level processing first; upon determining that the set of gesture sequence is not a swipe, the gesture sequence is sent to the application for application level processing first.

### BACKGROUND OF THE INVENTION

1. Field of the Invention

The present disclosure relates to a method for defining order of priority for handling touch-based gestures, and in particular for a user defining a set of gesture sequence controlling an order of priority for processing assignment by an application program itself or by the system of a device hosting the application program.

2. Description of Related Art

In recent years, the touch-based gestures (including multi-touch) have become popular, and these gestures can be interpreted directly by an application program itself if the application program (or app) wants to handle the such function triggered by the corresponding gesture, or the corresponding gestures can be interpreted by the system of a device if the application program does not handle such interpretation function itself, and meanwhile, the system of the device can be configured to handle such gesture function. And it is difficult to distinguish as to whether each of the touch-based “swipe” operation made by a user belongs to the application program or to the system. One simple method is to allow the application program to handle the interpretation of the gestures first, and if such gesture is not recognized by the application program, it is then passed over to the system of the device for further interpretation. As can be seen easily, such conventional method has inherited limitations.

Usually, a touch-based smartphone comprises of two major display areas, in which one area is configured as a main UI display area, and the other display area is configured as a menu area to display a plurality of menu buttons for functional operation capabilities. And in many modern smartphone designs, these two display areas are formed at or on the same surface, and it is easy to perform swipe gesture operations that extend across these two display areas by the user.

Usually for swipe-gestures or touch-based gesture swipes, the application program will only recognize if when the gesture has occurred in the “Main UI display area”. Meanwhile, such touch swipe gesture would not have been detected when performed in the “menu area”, but instead, it is typically a press and tap operation which is detected correspondingly, and such tap or press operation will invoke an action operation such as “go back to previous app”, “open the menu”, “search”, and “return to home”, etc. . . .

### BRIEF DESCRIPTION OF THE DRAWINGS

FIGS. 1a-1b shows a system of an electronic device activated to pop up a new window for allowing operation in that new window upon a user to tap on a system icon.

FIG. 2 illustrates when a detected gesture is acknowledged as being intended to be handled by the application program itself upon the start position is detected as being actuated in the Main UI display area.

FIG. 3 exemplifies a system gesture mode in which the application program skips over from processing such detected gesture.

FIG. 4 shows a flow chart of a method for defining a set of gesture sequence controlling an order of priority for processing assignment with respect to an operating system of a device hosting an application program, and to the application program itself according to a preferred embodiment of the present disclosure.

FIGS. 5a-5b show a left to right swipe defining one system gesture for invoking a window to pop up to allow the user to enter into various modes according to a third embodiment of present disclosure.

### SUMMARY OF THE INVENTION

An objective of the present disclosure is to provide a method for a user to define whether a predetermined touch-based gesture operation or command should be handled by an application program itself or by the system of a device hosting the application program, thereby making the predetermined gesture operation or command provided by the user to be much more straightforward, intuitive, and easy to understand when used in actual situations.

Another objective of the present disclosure is to provide a method for defining a set of gesture sequence controlling an order of priority for processing assignment with respect to an operating system of an electronic device hosting an application program, and to the application program itself.

To achieve the above-said objectives, the present invention provides a method for defining a set of gesture sequence controlling an order of priority for processing assignment with respect to an operating system of an electronic device hosting an application program, and to the application program itself, comprising the following steps: a start position is determined as whether being detected in a menu area, followed by detecting and determining if a set of gesture sequence is a swipe; upon determining that the starting point is not detected in the menu area, the gesture sequence is sent for application level processing first; upon determining that the set of gesture sequence is a swipe, the gesture sequence sent for system level processing first; upon determining that the set of gesture sequence is not a swipe, the gesture sequence is sent to the application program for application level processing first.

To achieve the above-said objectives, the present invention defines a start position as being a first touch point(s) upon when a touch gesture is detected by the electronic device, and defines an end position as being a final touch point(s) upon when the touch gesture is detected by such device in the method using a set of gesture sequence for controlling an order of priority for processing assignment. If the start position is detected or sensed as being actuated in a main UI display area, this detected gesture is then acknowledged as being intended to be handled by the application program itself, and such detected gesture is called an application level gesture. If the start position is actuated upon when a corresponding gesture is detected in the menu area, this detected gesture is then acknowledged as being intended to be handled by the system of the device, and such operating mode can also referred to as a system gesture mode, and therefore, the application program should skip over from handling or processing such detected gesture and pass processing responsibility over to the system of the device.

By adopting the method for defining one set of gesture sequence controlling the order of priority for processing assignment of instant disclosure, the functionality of gestures performed in the menu area is expanded from being just merely press and tap operations, but also to include also a new “combined menu area plus main UI display area swipe” gesture operation or command. In addition, no false triggers would occur because the algorithm can effective distinguish between the “press and tap” conventional gesture operations occurring in the menu area versus the new “combined menu area plus main UI display area swipe” gesture operation.

### DETAILED DESCRIPTION OF THE INVENTION

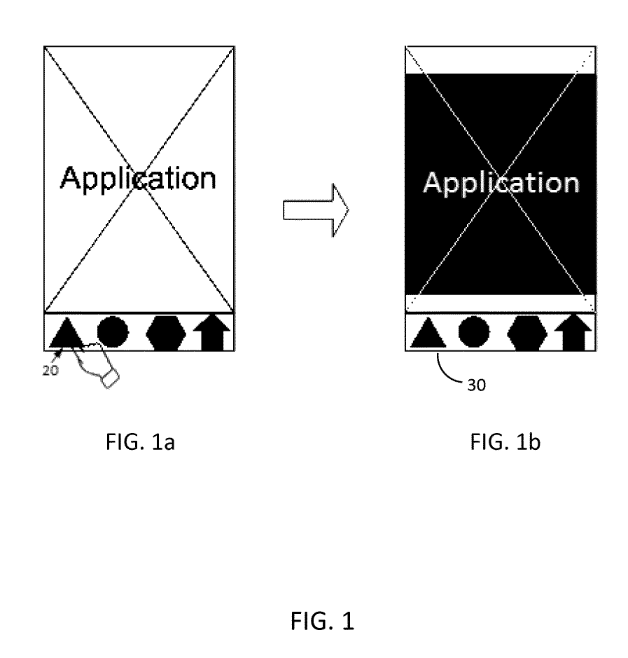

According to a first embodiment of the present disclosure, an application is running in an electronic device and is managed by the operating system of the electronic device. In addition, a system icon 20 is found in a system menu area 30 of the electronic device (not shown) as shown in FIGS. 1a-1b. As shown in FIGS. 1a-1b, upon a user clicks or taps the system icon 20, the system is activated to pop up a new window (not shown), and allowing the user to operate in that new window. And all of the gestures that are performed by the user in that new window are handled by the operating system of the electronic device instead of the application itself. And the new window can be a portion of the whole screen or even the entire full screen, and the system gestures can also reach across the window area and the rest of the touch screen area once they are being recognized as the system gestures.

In an alternative embodiment of present disclosure, the gestures that fit certain patterns can be allowed to be interpreted as system level gestures.

According to the first embodiment, a method for defining the order of priority using a set of gesture sequence for controlling the order of priority for processing assignment (defining a decision criteria for setting the correct or a desired particular order for prioritizing specific processing assignment based on predefined set of gesture sequence so as to decide whether to allocate the processing assignment to the application program itself or instead, to the system of the electronic device hosting the application program therein), a start position is defined as being a first touch point(s) upon when a touch gesture is detected by the device, and an end position is defined as being a final touch point(s) upon when the touch gesture is detected by such device.

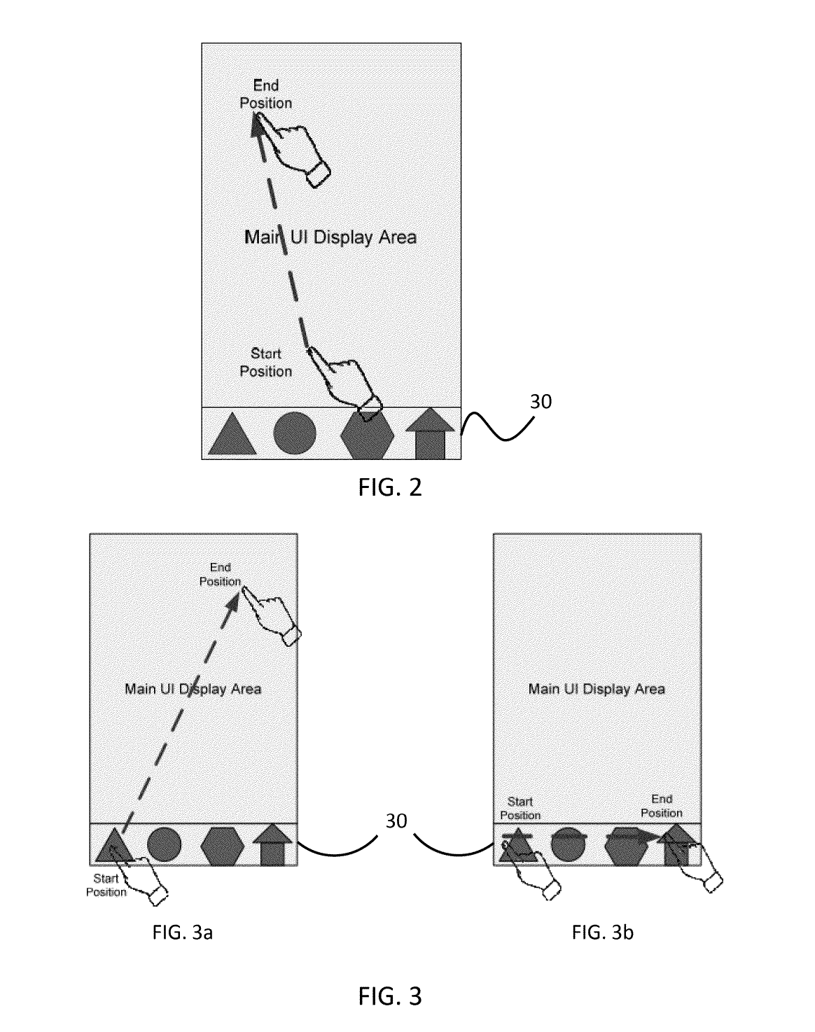

A menu area 30 can be configured for usage to support either with or without a touch screen. In the case of having a touch screen, such swipe gesture operation can be easily detected and sensed, so that it would be easy to define and actuate the start position; and in the case without having a touch screen, there is no touch screen support in the menu area 30, and another method is required to actuate a start position, and some of the implementation include the following steps:
1) Using one finger to keep or continue pressing down at one particular spot in the menu area 30, and then using another finger to perform a swipe gesture across in a particular direction in the main UI display area.
2) As shown in FIG. 2, if the start position is detected or sensed as being actuated in the main UI display area, this detected gesture is then acknowledged as being intended to be handled by the application program itself (in the sense that as the application has already occupies this display area), and such detected gesture can be referred to as an application level gesture.
3) As shown in FIG. 3, if the start position is actuated upon when a corresponding gesture is detected in the menu area 30, this detected gesture is then acknowledged as being intended to be handled by the system of the device, and such operating mode can also referred to as a system gesture mode, and therefore, the application program should skip over from handling or processing such detected gesture (in other words, the application program should ignore such gesture) and would then pass the handling or processing responsibility over to the system of the device. And under the system gesture mode, the event associated with the start point can be ignored, disregarded, or skipped over, because the intended purpose and goal for such detected gesture is only be used to distinguish whether such detected gesture belongs to an application level gesture or a system level gesture.

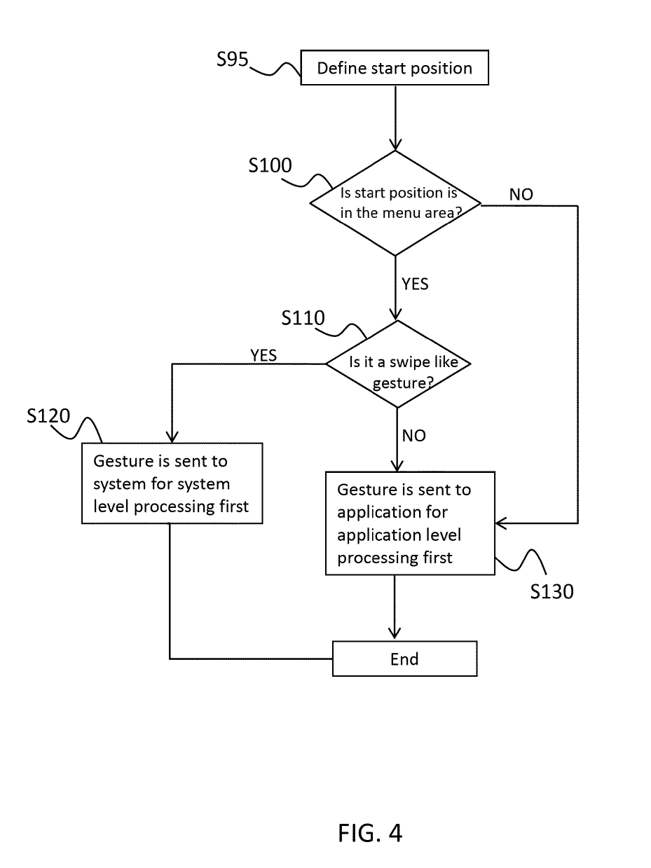

FIG. 4 shows a flow chart of a method for defining a set of gesture sequence controlling an order of priority for processing assignment with respect to an operating system of a device hosting an application program, and to the application program itself according to a preferred embodiment of the present disclosure. Referring to FIG. 4, in the preferred embodiment, the method for defining the set of gesture sequence controlling the order of priority for processing assignment by the application program itself or by the operating system of a device hosting the application program is described in the following steps:
Step S95: defining a start position as being a first touch point upon when a touch gesture is detected by the device;
Step S100: determining if the start position is detected in the menu area;
Step S110: upon determining that the starting position is detected in the menu area, detecting a set of gesture sequence, and determining if the set of gesture sequence is a swipe; upon determining that the starting position is not detected in the menu area, the gesture sequence is recognized as an application level gesture and sent to the application for application level processing first; jump to Step S130;
Step S120: upon determining that the set of gesture sequence is a swipe, the gesture sequence is recognized as a system gesture other than menu command and is sent to the operating system for system level processing first;
Step S130: upon determining that the set of gesture sequence is not a swipe or that the start position is not detected in the menu area, the gesture sequence is recognized as being a push and tap gesture or as being not of a system gesture, respectively, and is sent to the application program for application level processing first.

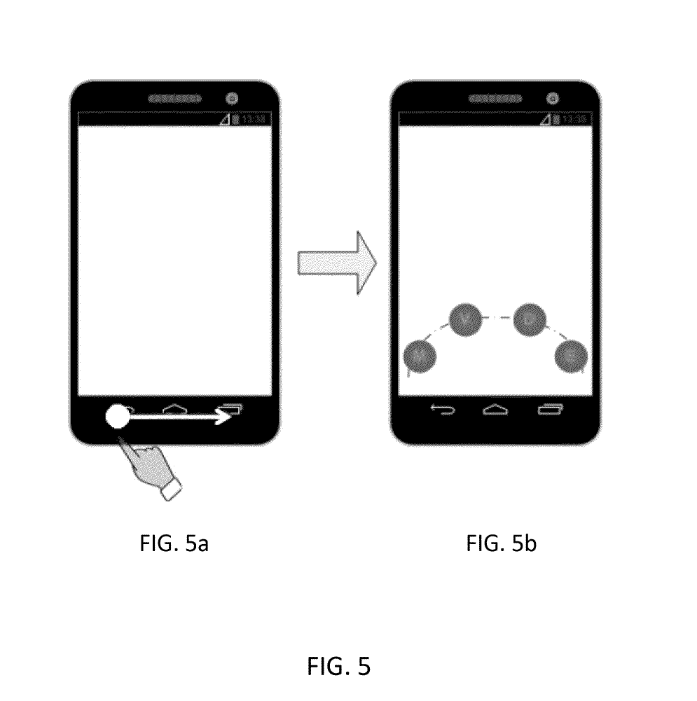

According to the above embodiments, one system gesture can also be defined by a set of gesture sequence, so that the set of gesture sequence will invoke a window to allow further more flexible system gestures in that window or reaching across that window. For example, according to a third embodiment of present disclosure, a left to right swipe is a set of gesture sequence defining one system gesture, and upon performing this set of gesture sequence by the user, a window or new page is invoked to pop up to allow the user to enter into various modes, such as, “M”, “V”, “D”, and “E” as shown in FIG. 5b

It will be apparent to those skilled in the art that various modifications and variations can be made to the structure of the invention without departing from the scope or spirit of the invention. In view of the foregoing, it is intended that the present invention cover modifications and variations of this invention provided they fall within the scope of the following claims and their equivalents.

What is claimed is:

1. A touch-based electronic device, comprising:
a surface; and
two display areas formed at the surface,
wherein one display area is configured as a main UI display area, and the other display area is configured as a menu area to display a plurality of menu buttons for functional operation capabilities, and a user is capable of performing swipe gesture operations that extend across the main UI display area and the menu area in a continuous motion, performing one or more gesture detections in the menu area comprising a press and tap operation and a combined menu area plus main UI display area swipe operation, and recognizing the combined menu area plus main UI display area swipe operation without launching false trigger.

2. A method for defining an order of priority for processing assignment by a user, comprising the steps of:
configuring two display areas at a surface of the electronic device, wherein one display area is configured as a main UI display area, and the other display area is configured as a menu area to display a plurality of menu buttons for functional operation capabilities;
performing a set of gesture sequence comprising one or more swipe gesture operations that extend across the main UI display area and the menu area in a continuous motion by the user;
performing one or more gesture detections in the menu area comprising a press and tap operation, and a combined menu area plus main UI display area swipe operation; and
recognizing the combined menu area plus main UI display area swipe operation without launching false trigger for defining the order of priority for processing assignment with respect to an operating system of a device hosting an application program, and to the application program itself.

3. The method for defining the order of priority for processing assignment as claimed in claim 2, further comprising of the step of:
configuring the two display areas to be capable of multi-touch capability; and
determining between a push and tap gesture, a system level gesture and an application level gesture using multi-touch capability of the two display areas, and gathering and analyzing of a plurality of adjacent detected gesture data in the menu area.

4. The method for defining the order of priority for processing assignment as claimed in claim 3, wherein false trigger is prevented between the push and tap operation and the combined menu area plus main UI display area swipe gesture operation, between the push and tap operation and the application level gesture, and between the push and tap operation and the touch gesture detected at one spot in the menu area, by having one finger maintaining pressing down at the particular spot in the menu area for an extended period without releasing while performing the swipe operation in the main UI display area.

5. A method for controlling an order of priority for processing assignment using a set of gesture sequence with respect to an application program and an operating system of a device hosting the application program, comprising of the steps of:
defining a start position as being a first touch point upon when a touch gesture is detected by the device; and
defining an end position as being a final touch point upon when the touch gesture is detected by the device;
detecting and sensing one or more swipe gesture operation in the menu area to define and actuate the start position;
continuing pressing down at one particular spot in the menu area using one finger, and performing a swipe gesture across in a particular direction in the main UI Display area using an another finger;
acknowledging the detected gesture as being intended to be handled by the application program itself, if the start position is detected as being actuated in the main UI Display area;
acknowledging the corresponding detected gesture as being intended to be handled by the operating system of the device, skipping over from processing the corresponding detected gesture by the application program and thereby passing the processing responsibility over to the operating system of the device, and disregarding the event associated with the start point, if the start position is actuated upon when a corresponding gesture is detected in the menu area.

6. A method for controlling an order of priority for processing assignment using a set of gesture sequence with respect to an application program and an operating system of an electronic device hosting the application program, comprising of the steps of:
configuring the electronic device with or without a touch screen;
for the electronic device having the touch screen, defining a start position as being a first touch point upon when a touch gesture is detected by the electronic device, and an end position as being a final touch point upon when the touch gesture is detected by the electronic device; detecting and sensing a swipe gesture operation in the menu area in the touch screen, so as to define and actuate the start position;
for the electronic device without having the touch screen, actuating the start position by holding down a particular menu button for a designated duration of time; continuing pressing down at one particular spot in the menu area using one finger, and performing a swipe gesture across in a particular direction in the main UI Display area using another finger;
if the start position is detected as being actuated in the main UI Display area, acknowledging the detected gesture as an application level gesture and as being intended to be handled by the application program itself;
if the start position is actuated upon when the corresponding detected gesture is actuated in the menu area, acknowledging the detected gesture as being intended to be handled by the operating system of the electronic device, and defining the operating mode to be a system gesture mode, and the application program skipping over from processing the detected gesture and passing the processing responsibility over to the operating system of the electronic device; under the system gesture mode, the event associated with the start point is thereby disregarded.

7. A method for defining a set of gesture sequence controlling an order of priority for processing assignment between an application program itself or an operating system of a device hosting the application program, comprising the steps of:
defining a start position as being a first touch point upon when a touch gesture is detected by the device;
determining if the starting point is detected in the menu area;
upon determining that the starting point is detected in the menu area, detecting a set of gesture sequence, and determining if the set of gesture sequence is a swipe;
upon determining that the starting point is not detected in the menu area, recognizing the gesture sequence as an application level gesture and sending to the application program for application level processing first;
upon determining that the set of gesture sequence is a swipe, recognizing the gesture sequence as a system gesture other than menu command and sending to the operating system for system level processing first;
upon determining that the set of gesture sequence is not a swipe, recognizing the gesture sequence as a push and tap gesture and sending to the application program for application level processing first.

8. The method for defining the set of gesture sequence for processing assignment as claimed in claim 7 wherein the set of gesture sequence is a left to right swipe, and upon performing the set of gesture sequence by the user, a window is invoked to pop up to allow the user to enter into a plurality of modes.
